(19) United States
(12) Patent Application Publication
(10) Pub. No.: US 2004/0225511 A1
(43) Pub. Date: Nov. 11, 2004

(54) Method for phone solicitations

(76) Inventor: Mark B. Gould, Newport Beach, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/431,851

(22) Filed: May 7, 2003

(51) Int. Cl. G06F 17/60

(52) U.S. Cl. 705/1

(57) ABSTRACT

A solicitation method comprises the steps of: providing a WAN accessible client prospects database, wherein the database comprises client telephone numbers; installing a solicitation software program into a computer system wherein the computer system has an automatic phone dialup feature and a WAN accessing feature; interconnecting the computer system with the client prospects database through the WAN over a telco system; and, for each of the client telephone numbers, at the computer system, in turn, presenting a client identity on a display of the computer system; executing automatic dialup of the respective client telephone number without disclosing the client telephone number; communicating a connection result, as good or bad, to the database; and compiling a service billing based on only the good connections.

### BACKGROUND OF THE INVENTION

INCORPORATION BY REFERENCE: Applicant(s) hereby incorporate herein by reference, any and all U.S. patents, U.S. patent applications, and other documents and printed matter cited or referred to in this application.

1. Field of the Invention

This invention relates generally to phone sales methods and more particularly to such a method wherein the sales representative is not made aware of the phone number contacted until the contact is made and wherein the sales representative is billed only when the person contacted and the phone number are found to correspond.

2. Description of Related Art

The following art defines the present state of this field:

Cameron et al., U.S. Pat. No. 5,737,726 describes a customer contact management system. The system can be customized in order to provide custom contact types and sub-types for the types of contacts relating to individual customers, groups of customers, and business entities. User preferences may be defined to further customize the system to provide the most convenient and time efficient searching, entry, and response actions. Prior contacts can be searched and located by generating filter criteria through the order-independent selection of contact types, contact sub-types, customer identification, and customer contact dates. Records detailing the nature of the customer contact can be stored, whether the contact is user-initiated, system-initiated, or customer-initiated. Internal messages and scripted messages are provided to assist the user of the system in conducting customer service activities. The number and frequency of the internal and scripted messages can be altered according to the experience level of the user.

Melchione et al., U.S. Pat. No. 5,966,695 describes an electronic sales and service support system and method for identifying sales targets using a centralized database to improve marketing success. The system includes a central database that receives comprehensive information from a variety of internal and external feeds, and standardizes and households the information in a three-level hierarchy (households, customers, and accounts) for use by a financial institution. The comprehensive information stored on the central database is accessed through micromarketing workstations to generate lists of sales leads for marketing campaigns. A database engine is provided for generating logical access paths for accessing data on the central database to increase speed and efficiency of the central database. The system distributes sales leads electronically to branch networks, where the sales leads are used to target customers for marketing campaigns. The central database is accessed by workstations of a central customer information system for profiling customers, enhancing customer relationships with the financial institution, and electronically tracking sales performance during marketing campaigns.

Miloslavsky, U.S. Pat. No. 6,130,933 describes a telephony call center system comprising an Internet connection adapted for receiving data from a WEB server, the data originating from the computer platform of a person browsing the Internet, including data identifying the browsing person, such as a telephone number, and indicating to the WEB server a desire of the browsing person to communicate with an agent at the call center. The communication desired may be (a) a request for an agent at the call center to receive a telephone call from a browsing person, or (b) a request for a call to be placed to the browsing person from the call center. In both (a) and (b) the practical result is a telephone conference between the browsing person and an agent at the call center. In the first instance (a), in response to the data from the WEB server to the call center, the call center provides to the WEB server, for transfer to the browsing person via the Internet, a telephone number of a routing point at the call center.

The call center selects an agent and initiates a watch for an arriving call from the browsing person. On arrival of the call, it is switched to the selected agent. In the other instance (b), in response to the data, the call center enters the browsing person's telephone number to a dialer and, when the dialer completes a call to the browsing person, switches the call to a selected agent.

Hammons et al., U.S. Pat. No. 6,477,509 describes a method and system for communication and trade on a network, in which information is directed at the computer screen of a consumer by merchants of goods, services, or information. A lending partner would provide the initial capital to offer the consumer an incentive for signing up for the system, and for supplying pertinent information about herself. A management system would integrate the merchant information with consumer information, to send a targeted stream of information to the user. Purchases could be made from the system, whether connected to the network or not. Background data transfer or auto-refreshing of data would be options for the system. The lending partner would be repaid for the consumer's incentive from revenues paid into the management system related to each individual consumer transaction.

Johnson, Jr. et al., U.S. Pat. No. 6,480,474 describes A digital communication network such as the Internet that is used to establish and control the telephone connections between two conferees with the telephone network being the means of exchanging verbal information. Each of the two conferees has a computer connected to the digital network, and each has an independent telephone instrument connected to the public switched telephone network. One of the conferees utilizes his computer containing appropriate software to initiate the call to the other conferee. The initiating conferee sends digital control information to a switch interface controlling a telephone switch as a gateway to the telephone network using SS7 control signals which implements the telephone connection between the conferees. The switch also provides telephone status information transmitted back over the digital network, and the status information is displayed on the computer monitors of the conferees.

Cook, U.S. 2002/0059095 describes a customer lead management system that relates to a system and method for collecting and organizing customer-marketing data, which is then made available to business representatives to assess. Specifically, using a computer network and, data on a potential customer's Budget, Authority, Needs, Timeline, and other related customer lead data is collected. After this data is collected the customer lead management system stores the customer lead data and ranks the viability of the customer based on the interest level of the customer lead and other variable criteria. The resulting customer lead profile is then stored in a database. The customer lead data is then capable of being accessed via a computer network by various companies that have goods/services that satisfy the needs and requirements of the customer lead. A company representative can be automatically notified when a customer lead profile has been updated.

Benson et al., U.S. 2002/0067820 describes a method of managing a call system for a computer telephony integrated call center system, said call center system comprising two or more customer call lists for at least one business telephony application, said method comprising: retrieving customer records for the same customer from a number of call lists; and combining said customer records to form a combined call list for said customer. A plurality of combined call lists for a plurality of customers is stored in a combined call list database. Whenever a call is outbound to a customer or inbound to a customer the combined list for that customer is displayed so that calls to that customer can be managed.

Chester, U.S. 2002/0095502 describes a system and method for establishing a secure virtual trading zone for customers of a service provider, in which bandwidth and applications are provided dynamically and in which the communication path is controlled. The service provider performs the following steps: receiving a request from a customer to establish communication with another customer; confirming the identity of each customer; transmitting to each customer executable code enabling encrypted communication therewith; obtaining from each customer information regarding the customer's computing environment; preparing a set of applications for use by each customer, in accordance with the customer information and the customer's request; transmitting the set of applications as executable code to each customer; establishing a communication path to each customer; and specifying the communication path to the customers, thereby permitting the customers to communicate over the path using those applications.

Bernstein, U.S. 2002/0107730 describes a method and apparatus for identifying potential customers for delivery of promotional materials. The method includes the steps of forming a customer profile by a vendor for targeting delivery of the promotional materials to potential customers, identifying customers which match the customer profile within a database of a third party and forwarding promotional materials to the identified customers.

The prior art teaches a method for identifying customers for delivery of promotional materials; a business to business system for intranet and Internet applications; a call management system using combined calling lists; a method for generating, capturing, and managing customer lead information over a computer network; a telephone call-back system controlled by an online data network in real time; an Internet marketing method and system; a metod for coordinating telephone and data communications; a sales and marketing support system using a graphical query prospect database; and a customer contact management system; but does not teach the present method of delivery from a sales lead database with confidential phone numbers, contacting the entities and after decision-making, receiving billing based on good sales leads only. The present invention fulfills these needs and provides further related advantages as described in the following summary.

### SUMMARY OF THE INVENTION

The present invention teaches certain benefits in construction and use which give rise to the objectives described below.

The present invention is a solicitation method comprising the steps of: providing a WAN accessible client prospects database, wherein the database comprises client telephone numbers; installing a solicitation software program into a computer system wherein the computer system has an automatic phone dialup feature and a WAN accessing feature; interconnecting the computer system with the client prospects database through the WAN over a telco system; and, for each of the client telephone numbers, at the computer system, in turn, presenting a client identity on a display of the computer system; executing automatic dialup of the respective client telephone number without disclosing the client telephone number; communicating a connection result, as good or bad, to the database; and compiling a service billing based on only the good connection results, i.e., where the telephone number called corresponds to the person being contacted.

A primary objective of the present invention is to provide an apparatus and method of use of such apparatus that provides advantages not taught by the prior art.

Another objective is to provide such an invention capable of automatically dialing prospective clients without disclosing the telephone number of the clients to the dialer.

A further objective is to provide such an invention capable of billing for only satisfactory connections made to the clients.

A still further objective is to provide such an invention capable of providing, in one software program, the ability to blind dial (without knowing the phone number), record good connections, log detailed information about contacted clients, including their telephone numbers, and set a reminder for callback of those connections not satisfactorily made.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a logic diagram of the preferred embodiment of the invention; and

FIGS. 2-7 are screen shots of several computer screens used to implement the present invention.

### DETAILED DESCRIPTION OF THE INVENTION

The above described drawing figures illustrate the invention in at least one of its preferred embodiments, which is further defined in detail in the following description.

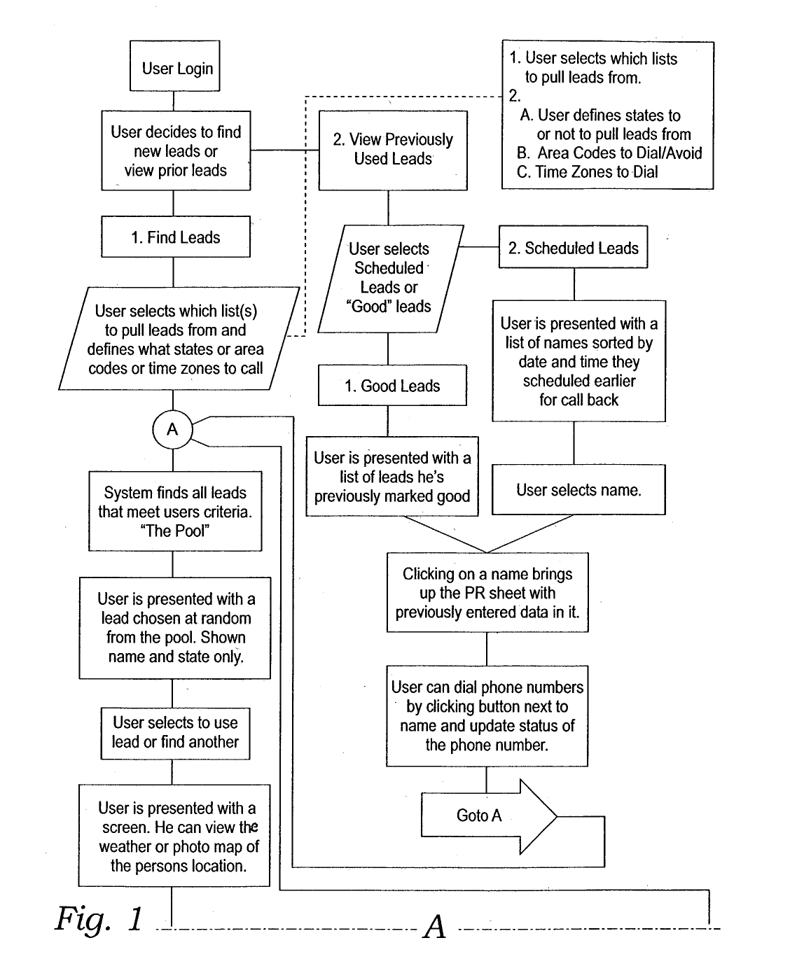

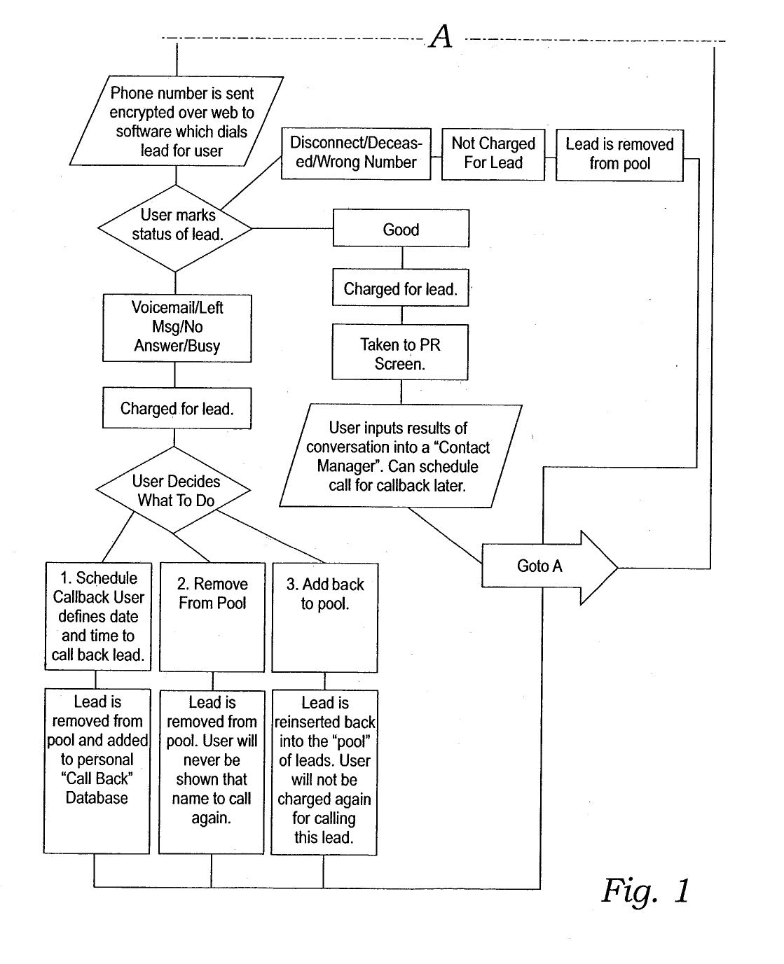

The present invention, as shown in FIG. 1, is a solicitation method using a wide area network, or WAN, accessible client prospects database. The method, shown in the logic diagram of FIG. 1, may be easily formed into a program set by those of skill in the software programming art. No part of such an instruction set would be outside the skill of a routing software engineer. Thus, the diagram of FIG. 1 fully discloses the invention and provides enablement. The WAN is preferably the Internet but may be any other network. The database comprises the telephone numbers and identities of prospective clients to a subscribing customer. The method further includes the steps of installing a solicitation software program which operates in accordance with FIG. 1, into one or more customer computer systems for each of the customers, typically telephone soliciting sales organizations. Each of the computer systems has an automatic phone dialup feature, such as a modem operated by any commercial operating software. The computer systems also have a WAN accessing feature such as Internet Explorerg, a product of Microsoft Corporation or any of the equivalent products well known in the art. Thus, interconnection between each computer system and the client prospects database through the WAN over a telco system such as any common carrier, is easily accomplished and such is well known in the art. In operation, each of the provided client telephone numbers, in turn, is brought-up on one of the computer systems used by a subscribing customer. The customer is presented with the client identity for the telephone number on a display of the computer system, but not the telephone number itself. Automatic dialup of the respective client telephone number is accomplished as is well known in the art, and, again, without disclosing the prospective client's telephone number to the customer. At this time, the customer may make contact with the prospective client and this may result in a benefit to the customer, such as acceptance by the client of a sales contract for an item or service the customer is soliciting. It may also result in a negative or a neutral result as is well known in the sales industry. If the phone number dialed is busy, the number can be identified for later contact. If the phone number is inactive, the customer can cancel billing for it.

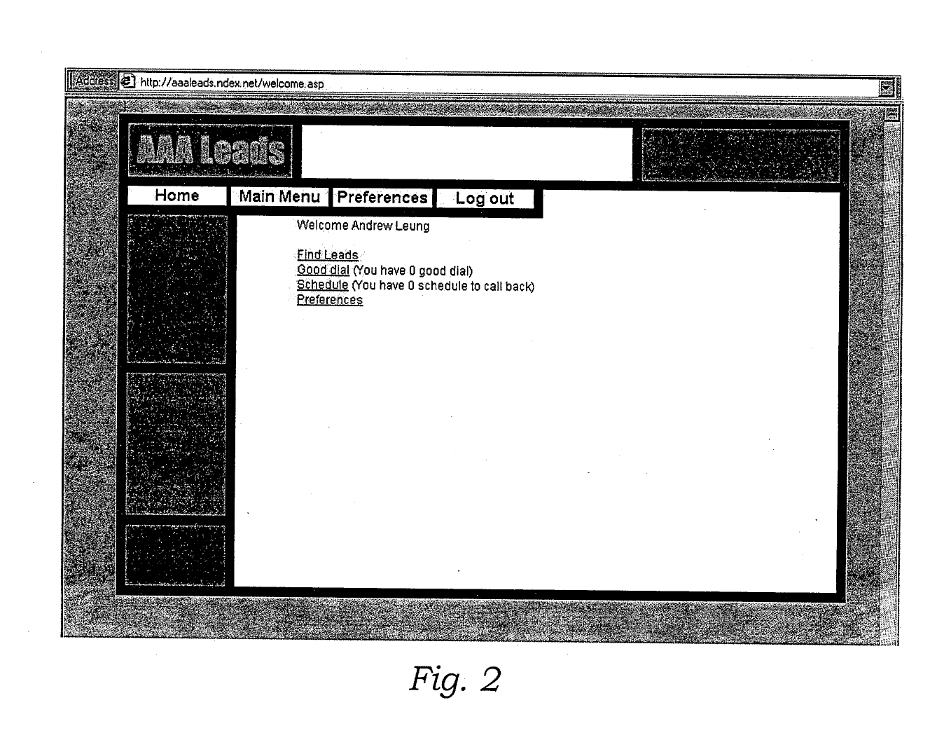

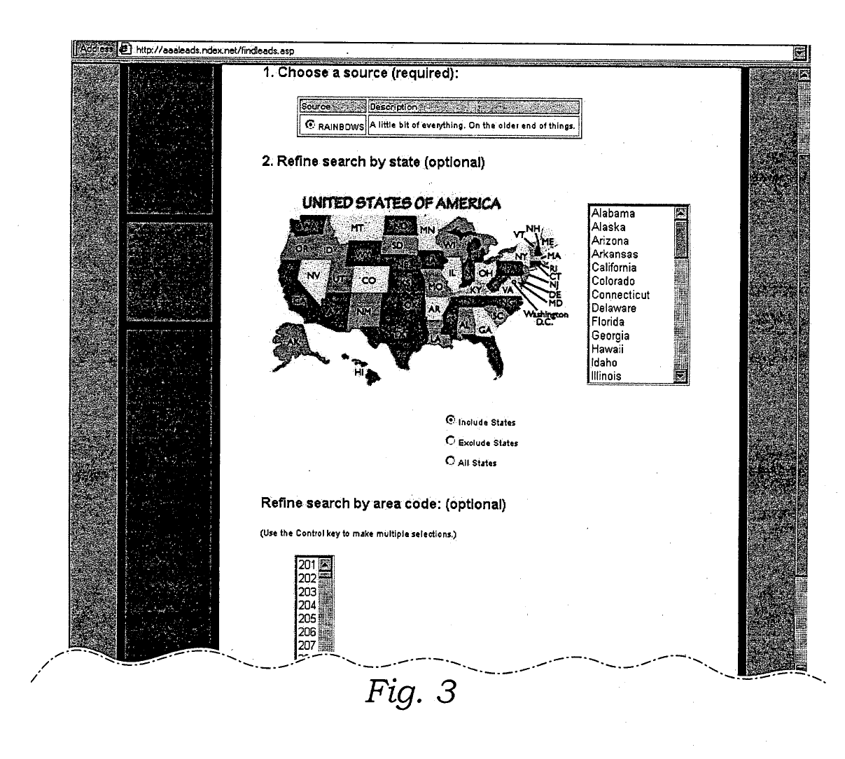

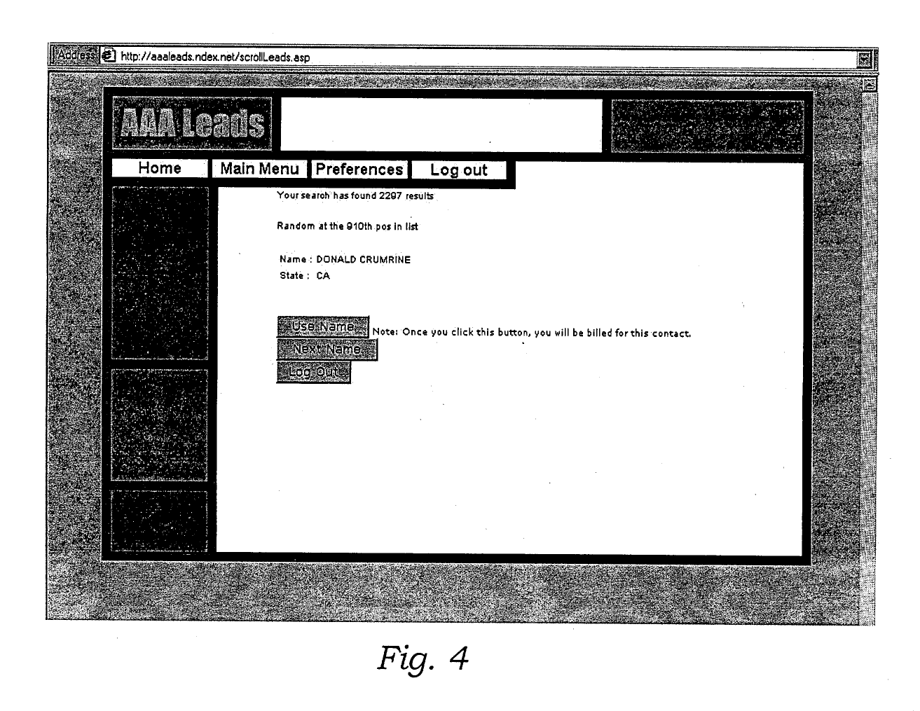

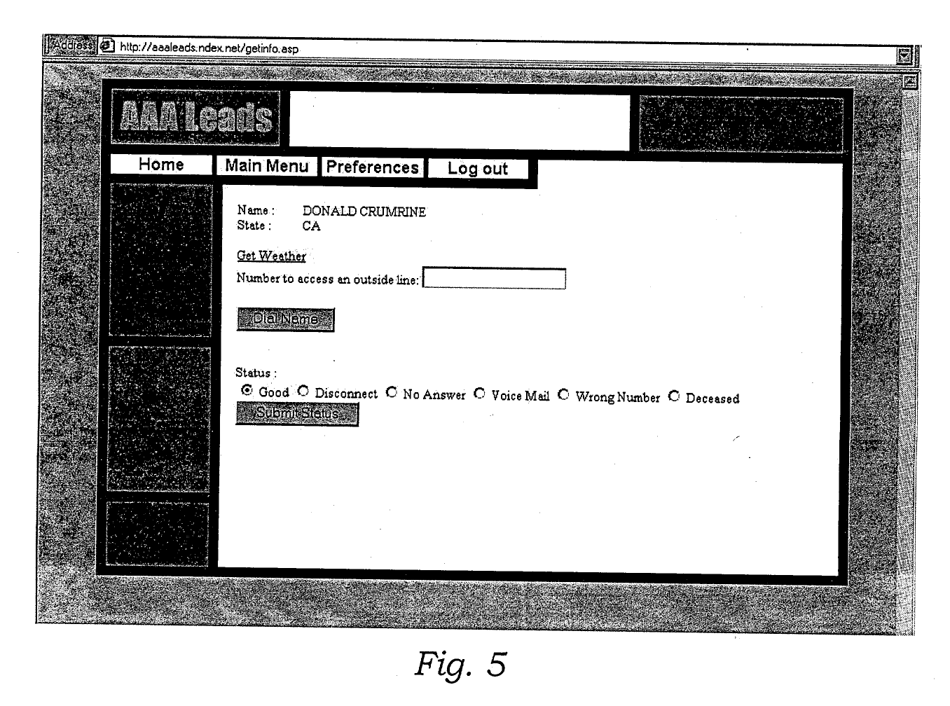

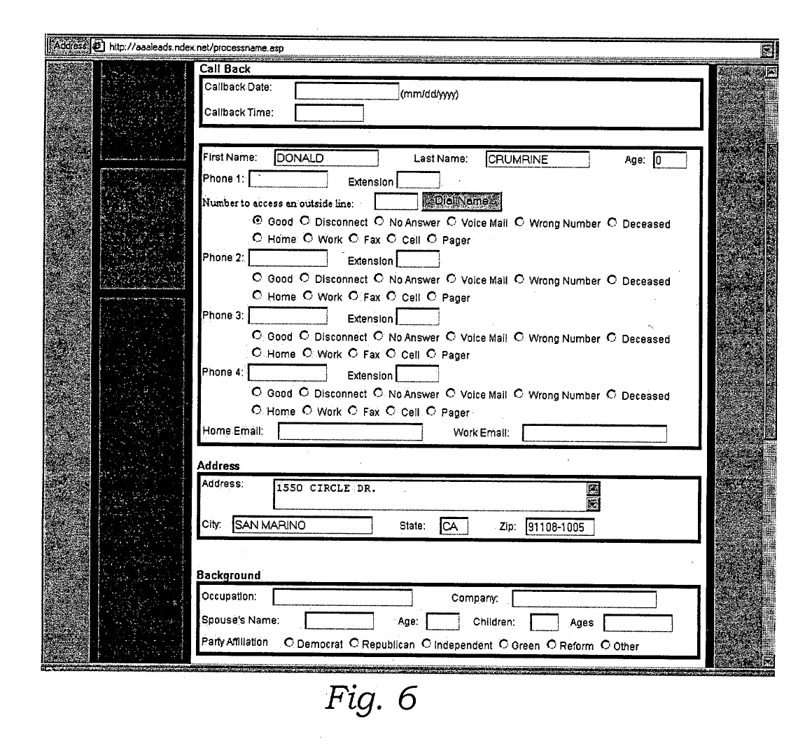

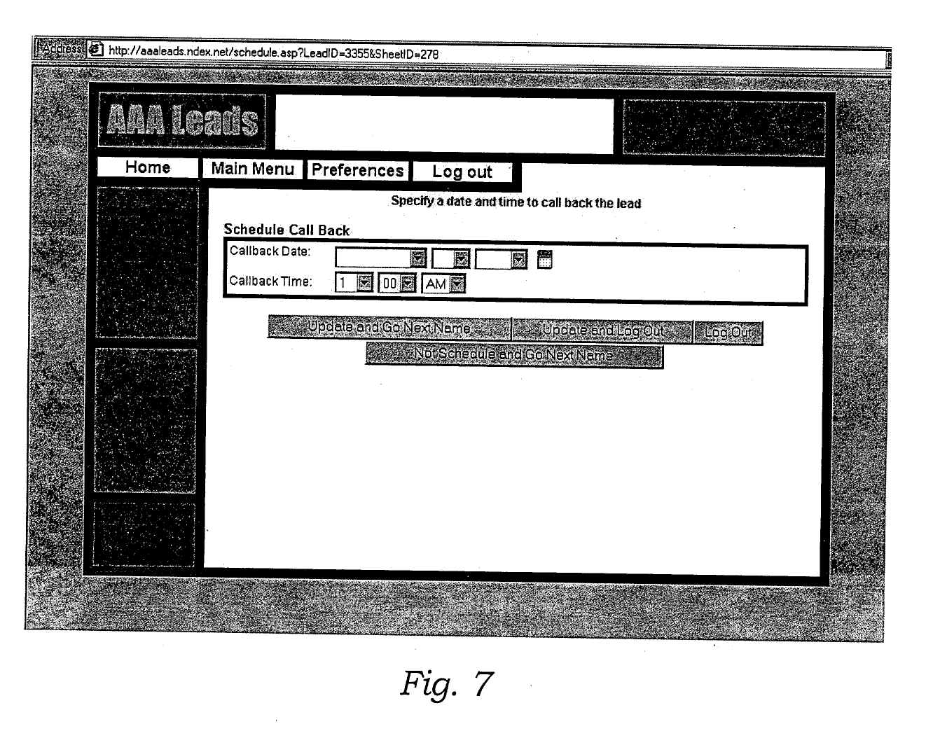

Referring now to FIGS. 2-7, which are screen shots of several of the screens used in the present method, we see in FIG. 2, a welcome screen which appears upon initialization of the present method. Choices may be made by mouse selection, or otherwise, from: Find Leads, Good Dial, Schedule and Preferences. Upon selection of Find Leads, the screen of FIG. 3 appears, from which a source of database information may be made including geographical selections. This screen is only an example of the types of choices that may be made, and such choices may extend to many other categories including industry, phone area, etc. Once the database has been selected, as shown in FIG. 4, the size of the database is displayed and the first entry or element in the database is identified. In this case, Donald Crumrine is the first client prospect for this customer. One may chose to use the name presented or move to the next name. In the screen of FIG. 5, we see that the customer may act to dial the client and this is done automatically without disclosure of the client's phone number. A status may be selected depending on the outcome of the call. In FIG. 6 we see that details may be logged by the customer for the prospective client, including, callback information and client contact information and client background. Moving to the screen of FIG. 7, we see that the customer may schedule a reminder to call the client back at a future date and time.

As defined, the present method enables the user of the method to designate each phone contact provided in the database as a good or bad contact, i.e., operating and correct phone number to the designated name, or not, and to thus control billing to only the so-called good numbers. The service billing will therefore be based on only the good connection results.

One may at any time revise the selection of the database in accordance with at least one of: a geographical, time, zone, standard industrial code, mail zip code, and telephone area code or any other preference.

One may, also, identify selected ones of the clients for reconnection at a later time, including setting an automatic reminder to call on a specific selected date and time of day.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A solicitation method comprising the steps of: providing a WAN accessible client prospects database, wherein the database comprises client telephone numbers; installing a solicitation software program into a computer system wherein the computer system has an automatic phone dialup feature and a WAN accessing feature; interconnecting the computer system with the client prospects database through the WAN over a telco system; and, for each of the client telephone numbers, at the computer system, in turn, presenting a client identity on a display of the computer system; executing automatic dialup of the respective client telephone number without disclosing the client telephone number; communicating a connection result, as good or bad, to the database; and compiling a service billing based on only the good connection results.

2. The method of claim 1 further comprising the step of selecting the database in accordance with at least one of; a geographical, time zone, standard industrial code, mail zip code, and telephone area code preference.

3. The method of claim 1 further comprising the steps of identifying selected ones of the client identity and enabling said selected ones for re-dialup at a later time.

4. A solicitation method comprising the steps of: providing a WAN accessible client prospects database, wherein the database comprises client telephone numbers; installing a solicitation software program into a plurality of computer systems wherein each of the computer systems has an automatic phone dialup feature and a WAN accessing feature; interconnecting the computer system with the client prospects database through the WAN over a telco system; and, for each of the client telephone numbers, in turn, on one of the computer systems, presenting a client identity on a display of the computer system; executing automatic dialup of the respective client telephone number without disclosing the client telephone number; communicating a connection result, as good or bad, to the database; and compiling a service billing based on only the good connection results for one of, each and all of the computer systems.

5. The method of claim 4 further comprising the step of selecting the database in accordance with at least one of; a geographical, time zone, standard industrial code, mail zip code, and telephone area code preference.

6. The method of claim 4 further comprising the steps of identifying selected ones of the client identity and enabling said selected ones for re-dialup at a later time.
